(19) United States
(12) Patent Application Publication
(10) Pub. No.: US 2015/0105058 A1
(43) Pub. Date: Apr. 16, 2015

(54) METHOD OF SIM/USIM PERSONALIZING USER EQUIPMENT

(71) Applicant: ACER INCORPORATED, New Taipei City (TW)

(72) Inventor: Chia-Yun Chuang, New Taipei City (TW)

(73) Assignee: ACER INCORPORATED, New Taipei City (TW)

(21) Appl. No.: 14/281,863

(22) Filed: May 19, 2014

Related U.S. Application Data
(60) Provisional application No. 61/890,882, filed on Oct. 15, 2013.

(30) Foreign Application Priority Data
Jan. 9, 2014 (TW) 103100833

(51) Int. Cl. H04W 8/18; H04W 4/00

(52) U.S. Cl. CPC H04W 8/183; H04W 4/001
USPC 455/418

(57) ABSTRACT

When SIM/USIM personalizing a user equipment, a unique ICCID, which is not protected by PIN, of a specific smartcard is used as feature data. Even in a PIN-locked status, the user equipment may directly access an integrated circuit card identity elementary file of a currently inserted smartcard and then determine whether the currently inserted smartcard is the specific smartcard without waiting for the PIN-unlock process to complete. Therefore, the present method of performing SIM/USIM personalization does not influence the efficiency of the booting process.

### CROSS REFERENCE TO RELATED APPLICATIONS

This application claims the benefit of U.S. provisional application No. 61/890,882 filed on 2013 Oct. 15.

### BACKGROUND OF THE INVENTION

1. Field of the Invention

The present invention is related to a method of SIM/USIM personalizing a user equipment, and more particularly, to a method of SIM/USIM personalizing a user equipment without influencing the efficiency of the booting process.

2. Description of the Prior Art

Subscriber identity module (SIM) is a smartcard that securely stores the international mobile subscriber identity (IMSI) used to identify and authenticate subscribers, short message service (SMS) data and contact information on mobile telephony devices. The hardware structure of a SIM card includes a central process unit (CPU), read-only memory (ROM), random access memory (RAM), electrically erasable programmable read-only memory (EEPROM), and an input/output (I/O) circuit. The hierarchical logic data structure of a SIM card includes 3 types of files: elementary file (EF), dedicated file (DF) and master file (MF).

According to the 3rd Generation Partnership Project (3GPP) specification TS 22.022, there are five features to personalize user equipment (UE): network personalization, network subset personalization, service provider (SP) personalization, corporate personalization, and SIM/USIM personalization. During the booting process, the UE obtains the IMSI from its SIM card, and passes this to the mobile operator requesting access and authentication. If the SIM card is locked, the user may have to pass a valid personal identification number (PIN) before the SIM card reveals this information.

In the prior art method, the UE is SIM/USIM personalized by storing the feature data (which is equivalent to the IMSI) of the relevant SIM/USIM card in the UE and setting the SIM/USIM personalization indicator in the UE to “ON”. Whenever a new SIM/USIM card is inserted, or the UE is powered up with a SIM/USIM card already in place, the international mobile subscriber identity elementary file (EF_{IMSI}) is read from the currently inserted SIM/USIM card and checked against the previously stored feature data. If there is a match, the UE may operate in a normal mode; if there is no match, the UE can only operate in a restricted mode.

FIG. 1 is a diagram illustrating the international mobile subscriber identity elementary file EF_{IMSI} of SIM/USIM cards defined in the 3GPP specification 51.011. Field 10 depicts the access condition of reading, updating, invalidating and rehabilatating the international mobile subscriber identity elementary file EF_{IMSI}. “PIN” means that EF_{IMSI} can only be read and rehabilitated with a valid PIN. “ADM” means that EF_{IMSI} can only be updated and invalidated by authorized administrators.

As depicted in FIG. 1, the read access of the international mobile subscriber identity elementary file EF_{IMSI} is PIN-protected. If a UE has been SIM/USIM personalized using a prior art method and then activates SIM lock, the UE can only access the international mobile subscriber identity elementary file EF_{IMSI} of its SIM/USIM card after unlocking its SIM/USIM card. Therefore, the prior art method of SIM/USIM personalizing a PIN-locked ME may influence the efficiency of the booting process.

### SUMMARY OF THE INVENTION

The present invention provides a method of SIM/USIM personalizing a user equipment. The method includes acquiring an ICCID of a specific smartcard; storing the ICCID of the specific smartcard in the user equipment as feature data; accessing an integrated circuit card identity elementary file of a currently inserted smartcard of the user equipment during a booting process; and the user equipment entering a normal mode when determining that the integrated circuit card identity elementary file matches the feature data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the international mobile subscriber identity elementary file of SIM/USIM cards defined in the 3GPP specification 51.011.

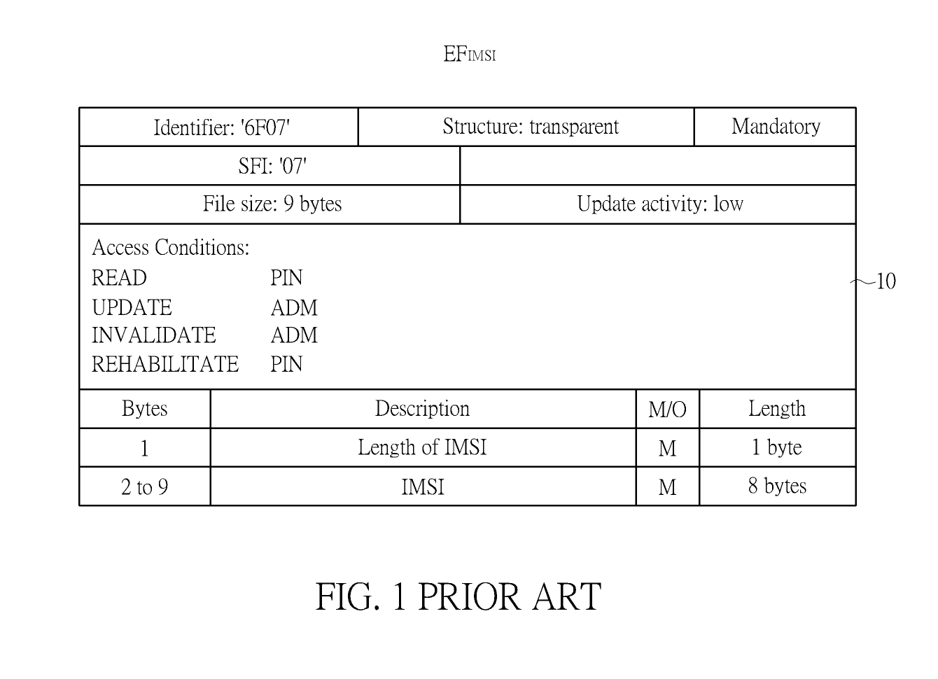

FIG. 2 is a flowchart illustrating a method of SIM/USIM personalizing user equipment according to the present invention.

FIG. 3 is a diagram illustrating the integrated circuit card identity elementary file of SIM/USIM cards defined in the 3GPP specification 51.011.

### DETAILED DESCRIPTION

The present invention provides a method of SIM/USIM personalizing user equipment without influencing the efficiency of the booting process even if the user equipment is PIN-locked. The present SIM/USIM personalization method maybe applied to electronic devices including, but not limited to, mobile telephones, personal digital assistants, handheld, tablet, nettop, or laptop computers, or other devices with similar telecommunication capabilities. However, the type of user equipment does not limit the scope of the present invention.

The present SIM/USIM personalization method maybe applied to user equipment inserted with various types of smartcards including, but not limited to, a SIM card for global system for mobile communications (GSM) system, a USIM card for universal mobile telecommunications system (UMTS), or a removable user identity module (R-UIM) card/code division multiple access (CDMA) user identity module (CSIM) card for CDMA systems. However, the type of the smartcard does not limit the scope of the present invention.

The present SIM/USIM personalization method may be applied to user equipment inserted a smartcard of various sizes including, but not limited to, a standard Mini SIM card, a Micro SIM card or a Nano SIM card. However, the size of the smartcard does not limit the scope of the present invention.

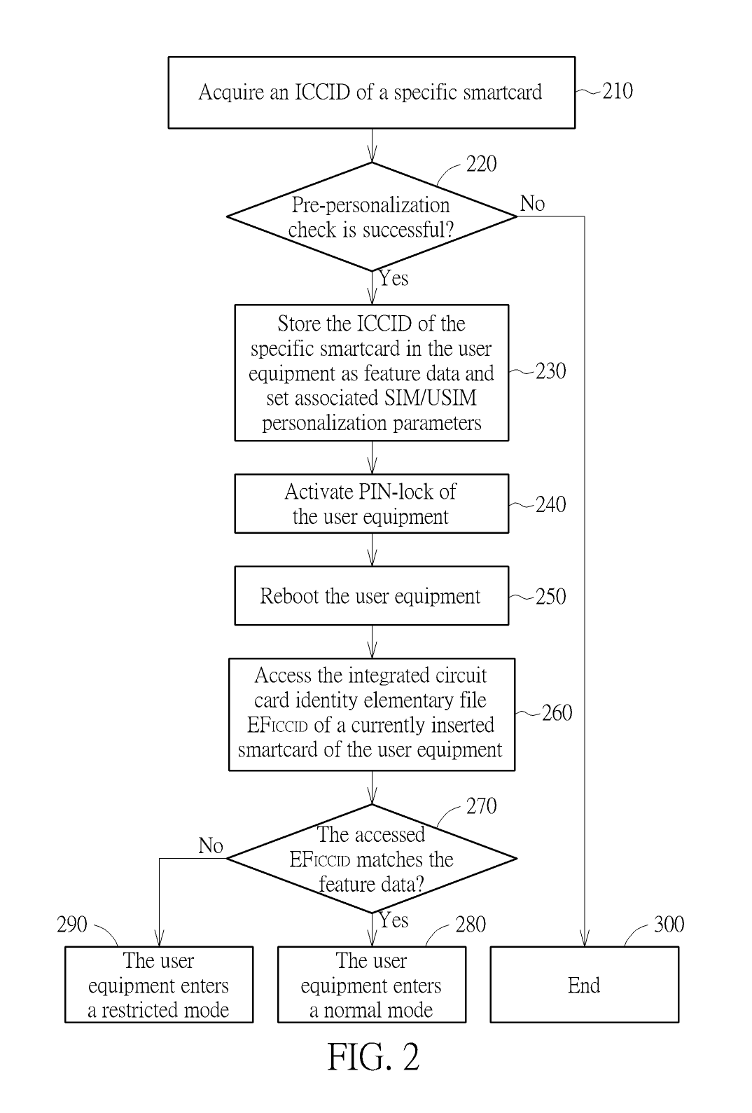

FIG. 2 is a flowchart illustrating a method of SIM/USIM personalizing user equipment according to the present invention. The flowchart in FIG. 2 includes the following steps:

Step 210: acquire an integrated circuit card identity (ICCID) of a specific smartcard; execute step 220.

Step 220: determine whether a pre-personalization check is successful: if yes, execute step 230; if no, execute step 300.

Step 230: store the ICCID of the specific smartcard in the user equipment as feature data and set associated SIM/USIM personalization parameters; execute step 240.

Step 240: activate PIN-lock of the user equipment; execute step 250.

Step 250: reboot the user equipment; execute step 260.

Step 260: access an integrated circuit card identity elementary file (EF_{ICCID}) of a currently inserted smartcard of the user equipment; execute step 270.

Step 270: determine whether the accessed EF_{ICCID} matches the feature data: if yes, execute step 280; if no, execute step 290.

Step 280: the user equipment enters a normal mode.

Step 290: the user equipment enters a restricted mode.

Step 300: end.

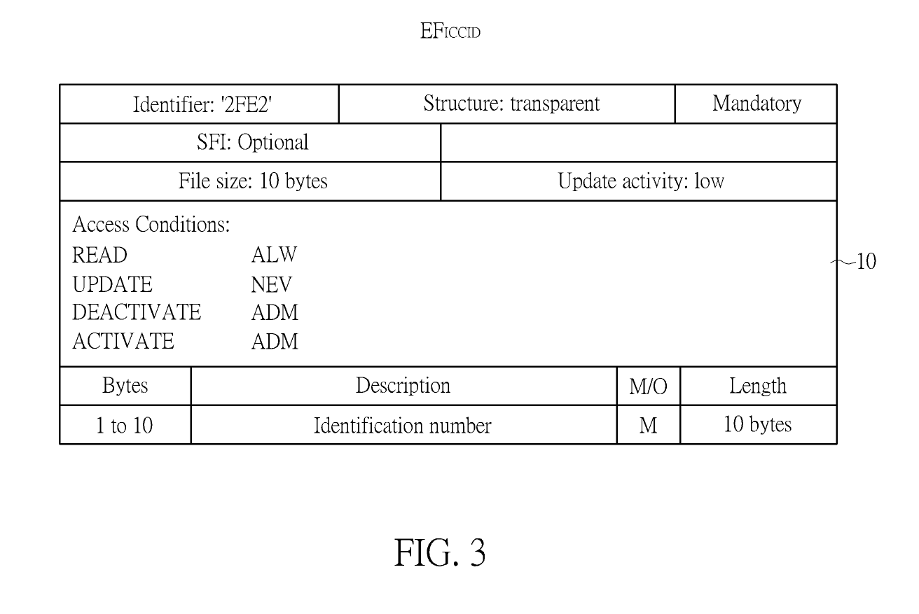

FIG. 3 is a diagram illustrating the integrated circuit card identity elementary file EF_{ICCID} of SIM/USIM cards defined in the 3GPP specification 51.011. Field 10 depicts the access condition of reading, updating, deactivating and activating EF_{ICCID}. “ALW” means that EF_{ICCID} can be read anytime . “NEV” means that EF_{ICCID} is not allowed to be updated at all time. “ADM” means that EF_{ICCID} can only be deactivated and activated by authorized administrators. As well known to those skilled in the art, the ICCID acquired in step 210 can be used to uniquely identify the specific smartcard.

In step 220, it is determined whether the pre-personalization check is successful. According to the 3GPP specification 22.022, during the personalization cycle of a category before any changes are made to the existing personalization data, the following two conditions shall be checked:

Condition 1: the category to be personalized is not currently activated;

Condition 2: the new codes to be stored are a subset of the existing codes

For example, in order to modify the entities of an active SIM/USIM personalization category, Condition 1 is satisfied only after de-personalizing the SIM/USIM personalization category. If the existing codes includes feature data N1 stored in the previously executed network personalization and feature data SU1 associated with the SIM/USIM personalization category is acquired in step 210, Condition 2 is satisfied only by updating the existing codes with (N1-SU1) and is not satisfied by updating the existing codes with (N2-SU1). If any of Condition 1 or Condition 2 is not satisfied, step 300 is executed for ending the SIM/USIM personalization.

In step 230, the ICCID acquired in step 210 is stored in the user equipment as feature data and associated SIM/USIM personalization parameters may be set when the pre-personalization check is successful. According to the 3GPP specification 22.022, setting SIM/USIM personalization parameters includes storing a personalization control key (PCK) and setting the status of a SIM/USIM personalization indicator. The PCK personalization control key is a decimal string of 6-16 digits and randomly selected for each user equipment by the service provider. Correct PCK must be entered in order to de-personalizing the user equipment in SIM/USIM personalization category. When the SIM/USIM personalization indicator is set to “ON”, it indicates that the SIM/USIM personalization has been activated; when the SIM/USIM personalization indicator is set to “OFF”, it indicates that the SIM/USIM personalization has been deactivated. In step 230, the SIM/USIM personalization indicator is set to “ON”. Under such circumstances, the user equipment is required to perform verifications during the booting process, which will be described in the subsequent paragraphs.

Since PIN-lock of the user equipment has been activated in Step 240, it is required to enter the correct PIN to unlock the user equipment so that the user equipment may enter the normal mode in step 280 or enter the restricted mode in step 290 according to the results of steps 260 and 270. The present invention may adopt any known method of locking/unlocking user equipment and is not limited thereto.

In step 260, the user equipment is configured to access the integrated circuit card identity elementary file EF_{ICCID} of its currently inserted smartcard during the booting process. In step 270, the user equipment is configured to determine whether the accessed EF_{ICCID} matches the feature data stored in step 230. If there is a match, it can be determined that the currently inserted smartcard is the one used to perform SIM/USIM personalization, and the user equipment is configured to enter the normal mode in step 280. If there is no match, it can be determined that the currently inserted smartcard is not the one used to perform SIM/USIM personalization, and the user equipment is configured to enter the restricted mode in step 290. In the present invention, the restricted mode may be an emergency calls only mode defined in the 3GPP specification TS 22.022 in which the user equipment shall use the temporary mobile subscriber identity (TMSI) assigned by the visitor location register (VLR) for making any emergency call request.

The present SIM/USIM personalization method uses the ICCID of a specific smartcard as feature data. The ICCID can be used to uniquely identify the specific smartcard and is not protected by PIN. Even in a PIN-locked status, the user equipment may directly access the integrated circuit card identity elementary file of a currently inserted smartcard and then determine whether the currently inserted smartcard is the specific smartcard without waiting for the PIN-unlock process to complete. Therefore, the present method of performing SIM/USIM personalization does not influence the efficiency of the booting process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of subscriber identity module/universal subscriber identity module (SIM/USIM) personalizing a user equipment, comprising:
acquiring an integrated circuit card identity (ICCID) of a specific smartcard;
storing the ICCID of the specific smartcard in the user equipment as feature data;
accessing an integrated circuit card identity elementary file (EF_{ICCID}) of a currently inserted smartcard of the user equipment during a booting process; and
the user equipment entering a normal mode when determining that the integrated circuit card identity elementary file matches the feature data.

2. The method of claim 1, further comprising:
the user equipment entering a restricted mode when determining that the integrated circuit card identity elementary file does not match the feature data.

3. The method of claim 2, wherein the user equipment is configured to perform more functions in the normal mode than in the restricted mode.

4. The method of claim 1, further comprising:
determining whether a pre-personalization check is successful; and
storing the ICCID of the specific smartcard in the user equipment as the feature data after determining that the pre-personalization check is successful.

5. The method of claim 4, wherein the pre-personalization check comprises:
verifying that the user equipment has not been SIM/USIM personalized before performing the booting process; and
verifying that the ICCID of the specific smartcard is a subset of an existing personalization code of the specific smartcard.

6. The method of claim 1, further comprising:
storing a personalization control key in the user equipment.

7. The method of claim 1, further comprising:
setting a SIM/USIM personalization indicator to an active state.
